(19) United States
(12) Patent Application Publication
(10) Pub. No.: US 2014/0094331 A1
(43) Pub. Date: Apr. 3, 2014

(54) CARBON FIBER ATHLETIC EQUIPMENT

(71) Applicants: George C. Hansen, Midway, UT (US); Nathan D. Hansen, Heber City, UT (US); Richard A. Dresden, Heber City, UT (US); Jon S. Bial, Woodland, WA (US); Gary Loomis, Woodland, WA (US)

(72) Inventors: George C. Hansen, Midway, UT (US); Nathan D. Hansen, Heber City, UT (US); Richard A. Dresden, Heber City, UT (US); Jon S. Bial, Woodland, WA (US); Gary Loomis, Woodland, WA (US)

(21) Appl. No.: 14/035,797

(22) Filed: Sep. 24, 2013

Related U.S. Application Data
(60) Provisional application No. 61/705,074, filed on Sep. 24, 2012.

(51) Int. Cl. F42B 6/04; B32B 1/08

(52) U.S. Cl. CPC F42B 6/04; B32B 1/08
USPC 473/578; 428/35.8

(57) ABSTRACT

Weighted arrow shafts and other athletic equipment composed of hollow shafts are constructed from carbon/graphite fibers. Such carbon/graphite fiber material may be at least in part coated with nickel or other metal or alloy to alter the weight of the carbon/graphite fiber material and, thus, the weight or weight distribution of the athletic equipment along the length of the hollow shaft.

### BACKGROUND OF THE INVENTION

1. The Field of the Invention

The present invention relates to the advancement of carbon/graphite arrow shaft technology by providing the ability to change the weight characteristics of the arrow shaft without appreciably affecting the physical dimensions of the shaft, and in particular, the wall thickness and outside diameter of the arrow shaft.

2. The Relevant Technology

Arrow shafts have been constructed from carbon/graphite fibers. In this regard, see U.S. Pat. Nos. 6,251,036 and 6,821,219, incorporated by reference herein.

Previously in carbon/graphite arrow shafts, the weight distribution along the length of the shaft was altered by varying the amount of composite material used to form the shaft. This changed the physical dimensions of the shaft, including the wall thickness. As a consequence, the flight characteristics, the stiffness, and the inserts used at the tip and tail of the shaft were detrimentally affected. Moreover, changing the weight of an arrow shaft by altering the amount of composite material used to form the shaft resulted in the weight of the shaft being monotonic along its length.

Accordingly, a need exists for a carbon/graphite fiber arrow shaft that may be weighted without altering the physical and aerodynamic characteristics of the arrow itself.

### BRIEF SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure pertains to athletic equipment constructed from elongated hollow shafts. Such equipment may include, for example, arrow shafts, baseball bats, softball bats, cricket bats, spears, harpoons, javelins, and pole vaulting poles. The hollow shaft portions of such athletic equipment may be composed of reinforcing/structural fibers arranged unidirectionally relative to each other. Such fibers may be disposed lengthwise or angularly with respect to the length of the shaft. Alternatively, the structural/reinforcing fibers may be of non-woven or random orientation in sheet form. Such sheets may be cut in patterns and wrapped, for example, around a mandrel to form the hollow shaft.

In addition, the unidirectional reinforcing fibers or non-woven fibers formed into sheets may be coated with a metal, thereby to increase or otherwise alter the weight of the shaft, either uniformly or differentially along the length of the shaft. This is accomplished by the amount of metal that is added to the reinforcing/structural fibers.

A scrim may be utilized, consisting of unidirectional, structural/reinforcing fibers or random-directional, non-woven, structural/reinforcing fibers in sheet form that extend around a shaft, thereby to increase the hoop strength of the shaft. The structural/reinforcing fibers comprising the scrim may also be coated with a metal, such as nickel, aluminum, silver, or copper, thereby to alter the weight of the scrim.

As in other types of hollow structures formed from layers of reinforcing/structural fibers, an adhesive resin material is used to bind the metal-coated unidirectional structural/reinforcing fibers or the non-woven fibers formed into sheets, as well as the structural/reinforcing fibers of the scrim.

The weight of the hollow shaft may be altered differentially along the shaft by utilizing a reinforcing scrim that has a gradient of metal applied to the reinforcing fibers of the scrim along the length of the scrim.

The metal applied to the reinforcing/structural fibers may be applied by electroplating, electroless plating, or chemical vapor deposition or vacuum deposition.

### BRIEF DESCRIPTION OF THE DRAWINGS

In order that the manner in which the above-recited and other features and advantages of the invention are obtained will be readily understood, a more particular description of the invention will be rendered by reference to specific embodiments thereof which are illustrated in the appended drawings. Understanding that these drawings only depict typical embodiments of the invention and are not therefore the be considered to be limiting of its scope, the invention will be described and explained with additional specificity and detail through the use of the accompanying drawings in which:

FIG. 1 is a schematic isometric view of a length of carbon/graphite fiber with a thin layer of metal (nickel) coating applied to the exterior of the fiber through a vapor deposition process;

FIG. 2 are schematic pictorial views of metal (nickel)-coated carbon/graphite fibers illustrating an increase in metal (nickel) coating thickness;

FIG. 3 is a schematic perspective view of a metal (nickel)-coated non-woven carbon/graphite fiber sheet with increased metal (nickel) coating from left to right;

FIG. 4 is a schematic isometric view of a pre-impregnated composite structure comprising of unidirectional metal (nickel)-coated carbon/graphite fibers and a polymer resin matrix depicted as a rectilinear form surrounding the nickel-coated carbon/graphite fibers;

FIG. 5A is a schematic perspective view of a composite structure comprised of one layer of pre-impregnated unidirectional metal (nickel)-coated carbon/graphite fiber with another layer of pre-impregnated unidirectional metal (nickel)-coated carbon/graphite fiber running perpendicular to the first layer;

FIG. 5B is a schematic perspective view of a composite structure comprised of one layer of pre-impregnated unidirectional metal (nickel)-coated carbon/graphite fiber with another layer of pre-impregnated non-woven metal (nickel)-coated carbon/graphite fiber paper;

FIG. 6A is a schematic isometric view of a metal (nickel)-coated composite material wrapped around a mandrel for baking purposes; and

FIG. 6B is a schematic isometric view of another metal (nickel)-coated composite material wrapped around a mandrel for baking purposes.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present invention includes forming the shaft portion of athletic equipment, including arrow shafts, by utilizing metal-coated, carbon/graphite woven fiber material or metal-coated, non-woven sheet material positioned at one or more selected locations along the length of the shaft. Such location could be, for example, at the tip portion of the arrow shaft or javelin. This construction can result in a significant increase in linear weight of the shaft at the tip with very small increase in the wall thickness and outside diameter of the shaft. As such, arrow shafts or javelins with an added weight advantage may be produced without significantly affecting the dimensions of the shaft wall thickness or diameter. This enables the arrow/javelin to be heavier and thus exhibit more kinetic energy to be imparted to the arrow/javelin. If the metal-coated woven fibers or non-woven fibers are distributed preferentially toward the front of the arrow/javelin, the differential pattern will produce a “weight forward” arrow/javelin for increased accuracy.

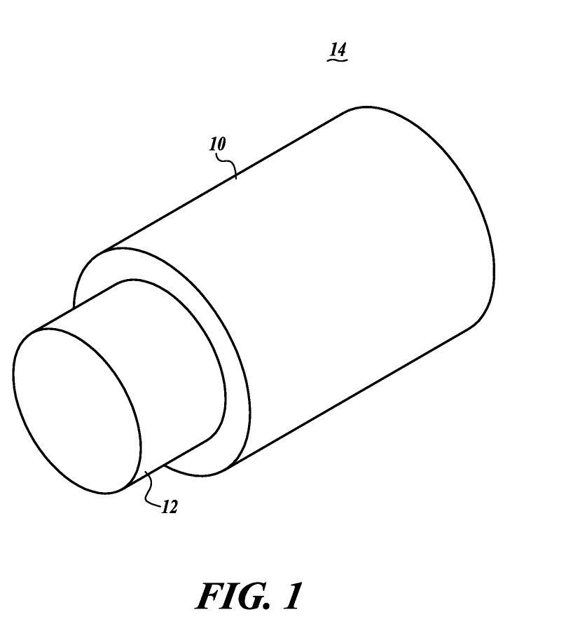

The metal-coated carbon/graphite fiber material 14, as illustrated in FIG. 1, composed of fibers 12 coated with a metal 14, can be placed at other locations along the shaft of an arrow or other athletic equipment in addition to just at the tip portion. For instance, the metal-coated carbon/graphite fiber material 14 can be positioned to achieve a gradual, but significant, weight change along the length of the shaft, or to achieve other desired weight characteristics throughout any portion of the shaft of an arrow, javelin, or other sports equipment. The following discussion will highlight some of the ways in which metal-coated carbon/graphite fibers may be utilized in order to manipulate the weight characteristics of the shaft of athletic equipment without significant changes to the diameter of the equipment shaft.

The carbon/graphite fiber is typically 3 to 7 microns in diameter. The nickel coating may range from 50 nanometers to 5 microns in diameter, depending on the weight percentage of nickel desired for the composite structure. With respect to the increased weight achieved by nickel or other metal-coated carbon/graphite fibers, the density of carbon fiber is 1.78 gm/cc. The linear weight of carbon fiber is substantially constant. For example, AS4-12K carbon fiber has a weight of about 0.80 g/m. By applying a relatively dense nickel (density is 8.92 gm/cc) or other metal coating to each graphite fiber, the weight of the carbon/graphite fibers can be significantly increased without appreciably increasing the thickness of the composite fiber material. For example, the diameter of a typical standard modulus carbon/graphite fiber is 7.0 μ. By adding a 20% nickel coating by weight to the fiber, the diameter of the carbon fiber only increases to 7.15 μ, but results in the coated fiber having a weight of 1.0 g/m as opposed to 0.80 g/m. The resulting composite is increased by weight by 13% but the volume is increased by only 2.5%. The density of the composite increases from 1.6 gm/cc for the regular carbon fiber composite, up to 2.1 gm/cc for the 20% nickel on the fiber composite. A typical 9 grain per inch arrow will now weigh 10.3 grains per inch.

Use of additional nickel or other metallic coating material to achieve a 50% weight increase of the composite material only increases the fiber diameter to 7.4 μ. This results in the coated carbon fiber having a weight of 1.6 g/m, or double the weight of uncoated carbon/graphite fiber. The density of the composite increases to 2.9 gm/cc, an increase of 80% over the base composite, while the volume of the composite increases only 8%. As such, an arrow that is 9 grains per inch with 0.250″ diameter and 0.020″ wall thickness will increase to 16 grains per inch, while the wall thickness will increase to 0.0215″ and the diameter will grow to a modest 0.253″.

In addition, a scrim may be utilized to extend carbon/graphite fibers transversely or angularly to the longitudinal carbon/graphite fibers to provide hoop strength to the arrow shaft. Such scrim will also help resist bending of the arrow shaft. Generally, the scrim contributes approximately 1.3 grains per inch. However, if the scrim is relatively lightly metal coated, for example with 50 grams per square meter of nickel, the scrim will contribute 3.2 grains per inch. If the scrim is 100 grams per square meter of nickel, it will contribute 5.0 grains per inch. This method can be used in addition to delivering the weight to the structural fiber.

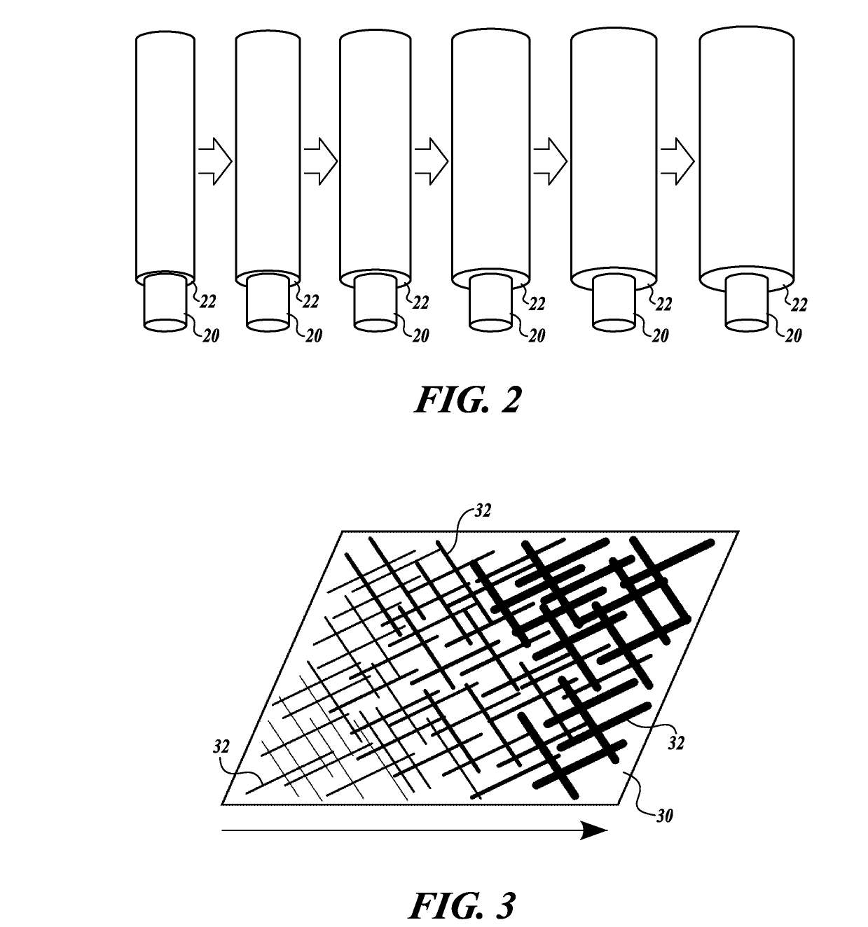

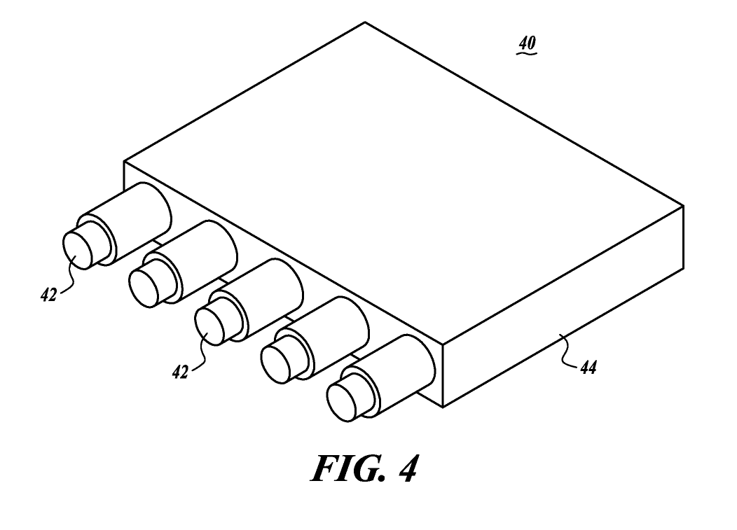

The scrim can be supplied with a variable amount of metal (nickel) from one side to the other. For instance, there may be no metal at one end of the arrow shaft and 100 grams per square meter of metal (nickel) at the other end of the arrow shaft. When used as such as the scrim for a shaft, it would result in a shaft that is 9 grains per inch at the rear and gradually increasing to 14 grains per inch at the front, with no special pattern and no discrete change in weight per unit length. Such scrim can made from either unidirectional metal (nickel)-coated carbon/graphite fiber 20 with an increased metal (nickel)-coating 22, as illustrated in FIG. 2, or from metal (nickel)-coated non-woven carbon/graphite fiber sheets 30 with an increased metal (nickel) coating on the carbon/graphite fibers, as illustrated in FIG. 3.

As illustrated above, a large increase of linear weight of the carbon/graphite fiber can be achieved with minimal increases in the diameter of the carbon/graphite fiber. As a result, the use of metal (nickel)-coated carbon/graphite composite in arrow shaft construction significantly increases the linear weight of the arrow shaft without a significant change in the physical dimensions of the arrow shaft, including the overall diameter or the wall thickness of the arrow shaft.

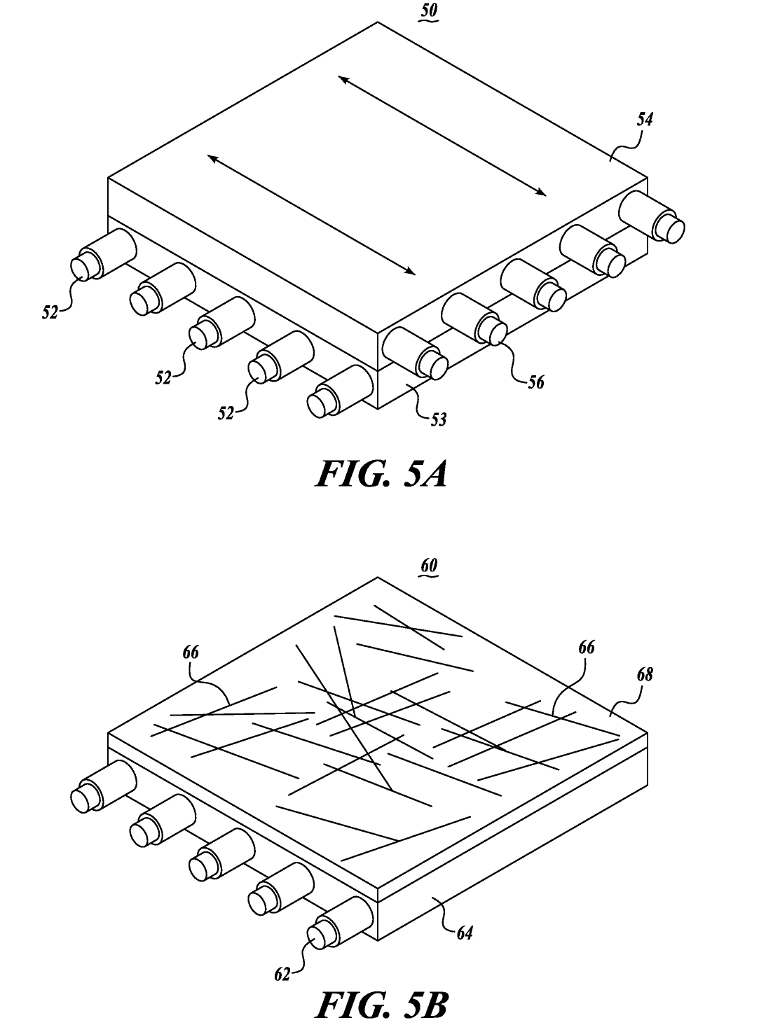

One advantage of the present disclosure is that carbon/graphite fiber arrow shafts can be constructed in substantially the same manner or methods used to construct current composite arrow shafts. In this regard, one or more patterns 40 for the arrow shaft can be cut from fibrous graphite material 42 embedded in resin 44, as illustrated in FIG. 4. One or more additional patterns can be cut from metal (nickel)-coated carbon/graphite unidirectional fibers or from metal (nickel)-coated non-woven carbon/graphite sheets. These materials are available from Conductive Composites of Heber City, Utah. The metal (nickel)-coated material can be designed to be placed at the tip portion of the arrow shaft or at other desired locations along the length of the shaft.

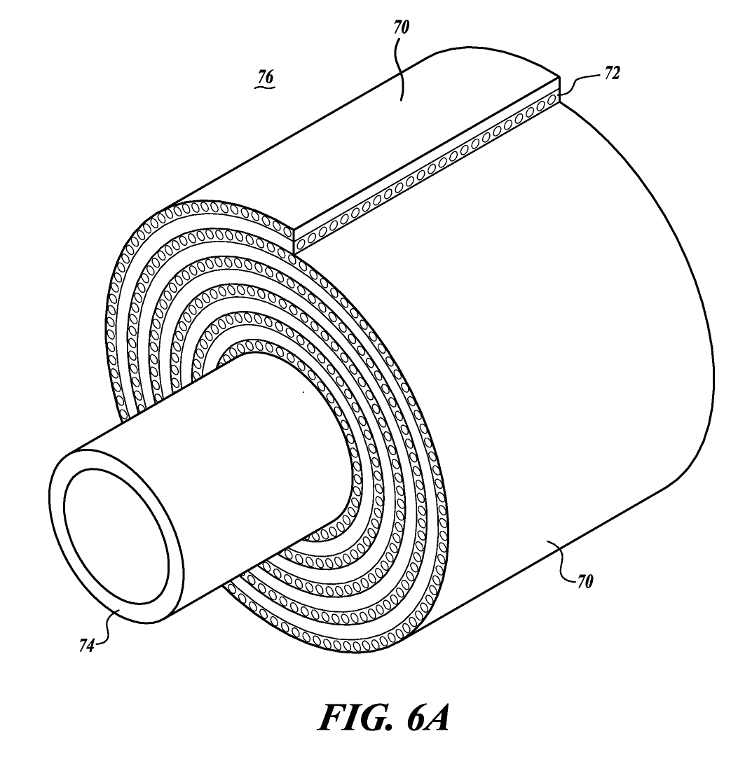

FIGS. 5A and 5B illustrate some possible variations of lay-up structures useful for producing tubular athletic equipment, including arrow shafts. The composite structure 50 of FIG. 5A is comprised of unidirectional metal (nickel)-coated carbon/graphite fibers 52 disposed on layers 53. Such fibers run longitudinally to the shaft structure for the primary structure of the composite. A scrim layer 54 comprised of unidirectional metal (nickel)-coated carbon/graphite fiber 56 is then placed perpendicular to the longitudinal unidirectional composite layers 53. The scrim layer 54 provides both increased conductivity and hoop strength to the composite structure. In addition, unidirectional metal (nickel)-coated fibers with increased weight percent, such as those in FIG. 2, may be placed closer to the tip portion of the arrow or along the length of the shaft in order to engineer desired weigh characteristics.

The composite structure of 5B is comprised of unilateral metal (nickel)-coated carbon/graphite fibers 62 in layers 64 in combination with metal (nickel)-coated carbon/graphite fibers 66 non-woven sheets 68. Layers 64 of unidirectional metal (nickel)-coated carbon/graphite fiber 62 run longitudinally to the antenna structure for the primary structure of the composite. The scrim layer 68 comprised of metal (nickel)-coated, non-woven sheets is then laid on top of the unidirectional fiber structure. This layer provides increased conductivity with hoop strength for the composite structure. In addition, the weight characteristics of this scrim layer may be engineered by modifying the amount of metal (nickel) coating applied throughout the scrim layer, as shown in FIG. 3. If a heavier tip is desired, a thicker metal (nickel) coating may be applied to the tip area of the scrim. If greater weight is desired in other portions of the shaft, this may be modified through the coating process of the non-woven sheets as well.

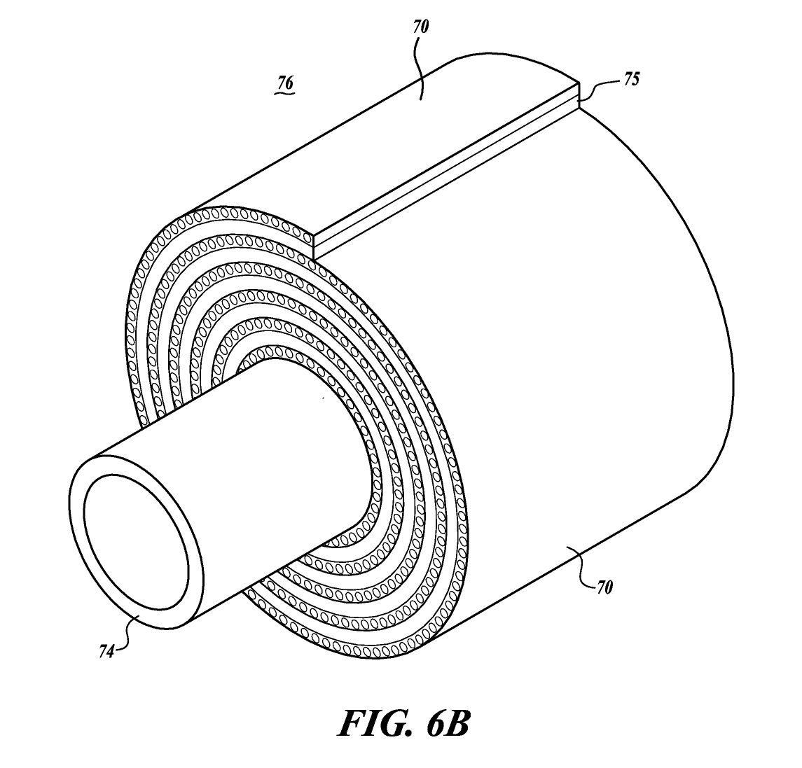

A metal (nickel)-coated carbon/graphite pattern(s) 70 of unidirectional metal-coated structural fibers with a scrim layer 72 of transverse unidirectional metal-coated carbon/graphite fibers are tightly wrapped over a mandrel 74, as illustrated by FIG. 6. Cellophane tape (not shown) is then wrapped over the standard carbon/graphite pattern(s) and metal (nickel)-coated carbon/graphite pattern(s) 70 to hold the patterns in place. Thereafter, the wrapped mandrel is baked at an appropriate temperature for an appropriate length of time so as to activate the resin. This baking process glues or binds the standard carbon/graphite fibers as well as the metal (nickel)-coated carbon/graphite fibers, along with the scrim, into a tubular structure to form the arrow shaft. During the baking process, the resin liquefies and penetrates through the graphite fibers and scrim. While baking, the cellophane tape shrinks tightly over the composite material wrapped around the mandrel.

After baking, the mandrel 74 is removed from the oven and cooled. Once cooled, the formed tubular graphite shaft 76 is removed from the mandrel 74, and the cellophane is removed. Thereafter, the resulting tubular-shaped athletic equipment shaft may be sanded to remove any ridges caused by the cellophane wrapping. Optionally, a colored or clear finish coat may be sprayed onto or otherwise applied to the shaft.

A further illustration of a layup for producing athletic equipment in accordance with the present disclosure is shown in FIG. 6B. As in FIG. 6A, FIG. 6B utilizes a metal (nickel)-coated carbon/graphite pattern composed of unidirectional metal-coated structural fibers wrapped around a mandrel 74. Although, rather than utilizing a scrim layer such as scrim layer 72, which is also composed of unidirectional metal-coated carbon/graphite fibers, the scrim layer 75 shown in FIG. 6B may be composed of a layer of pre-impregnated non-woven metal (nickel)-coated fibers disposed in a sheet and also wrapped around the mandrel 74 shown in FIG. 6B. This composite construction may be the same as or similar to the composite structure and described above with respect to FIG. 5B.

An athletic equipment shaft, made according to the present construction, results in a light-weight but strong and stiff structure that can be weighted as desired along the length of the shaft while still maintaining the substantially constant wall thickness and outer diameter of the arrow shaft. Moreover, if the metal (nickel)-coated woven carbon/graphite fibers or non-woven carbon/graphite sheet material is placed near the tip of the shaft, a true “weight forward” shaft may be produced.

Other possible athletic products in addition to arrow shafts that may be produced using the present invention include, for example, baseball bats, softball bats, cricket bats, spears, javelins, harpoons, and poles used for pole vaulting. As such, the present invention is not to be taken as limited to any of the specific features as described, but comprehends all such variations thereof as come within the scope of the appended claims.

While preferred embodiments of the present disclosure have been illustrated and described, it is appreciated that various changes can be made therein without departing from the spirit or scope of the present invention. In this regard, although nickel has been described as a metal for coating the woven or non-woven carbon/graphite fibers, other metals can also be utilized for the same function. Such additional metals include aluminum, copper, and silver.

Although the construction of the arrow shafts and other athletic equipment has been described in terms of structural or reinforcing fibers composed of carbon or graphite, other reinforcing/structural fibers may also be utilized, including synthetic polymers such as aramid, nylon, rayon, or acrylic. Moreover, natural fibers made from cellulose or silk may be utilized. In addition, fiberglass fibers may also be utilized.

The metal may be applied to the structural/reinforcing fibers using various techniques, including electroplating, electroless plating, and chemical vapor deposition. Chemical vapor deposition does have the advantage of being able to apply a wide range of the thickness of metal to the reinforcing/structural fibers, as illustrated in FIG. 2, also coating the fibers through a chemical vapor deposition method results in a more uniform, conformal, and ductile coating than when using other coating methods. This ductile coating leads to mechanical advantages over other prior metal coating and plating processes. Also, the chemical vapor deposition process allows for a wide range of coating levels uniformly applied to the structural fibers; thus the conductivity can be specifically engineered within a large range. For instance, whereas metal (nickel) coated carbon fiber is traditionally available in the range of approximately 40% nickel, vapor deposition enables fibers to be coated from 25% to 85% metal (nickel) by weight.

We claim:

1. Athletic equipment in the form of an elongated hollow shaft, comprising:
(a) the shaft comprising either reinforcing fibers unidirectionally arranged and oriented longitudinally of the shaft or non-woven sheets of reinforcing fibers disposed along the shaft;
(b) said unidirectional reinforcing fibers or said non-woven sheets of reinforcing fibers coated with a metal whereby the linear weight of the shaft may be bolstered without significantly increasing the wall thickness or diameter of the shaft;
(c) a scrim extending around the shaft to increase the hoop strength of the shaft, said scrim being composed of reinforcing fibers coated with a metal such that the linear weight of the shaft may be selectively altered with minimal increases in the wall thickness or diameter of the shaft; and
(d) an adhesive resin material to bind the metal-coated unidirectional reinforcing fibers or the non-woven sheets of metal coated structural fibers and the reinforcing fibers of the scrim.

2. The athletic equipment according to claim 1, wherein the weight of the shaft along the length of the shaft may be altered through the amount of metal coating added to the reinforcing fibers.

3. The athletic equipment according to claim 1, wherein the weight of the shaft may be altered by the amount of metal coating added to the reinforcing fibers of the scrim.

4. The athletic equipment according to claim 1, wherein weight is added to the shaft by the metal coating of the reinforcing fibers substantially uniformly along the length of the shaft.

5. The athletic equipment according to claim 1, wherein weight is distributed differentially along the length of the shaft by applying different patterns of reinforcing fiber containing various amounts of metal coating.

6. The athletic equipment according to claim 1, wherein weight is added differentially along the length of the shaft by utilizing a reinforcing scrim that has a gradient of metal applied to the reinforcing fibers of the scrim in a gradient along the scrim.

7. The athletic equipment according to claim 1, wherein said equipment is selected from the group consisting of arrow shafts, baseball bats, softball bats, cricket bats, spears, harpoons, javelins, and pole vaulting poles.

8. A shaft for an arrow comprising:
(a) either a plurality of unidirectional structural fibers oriented along the arrow shaft or sheets of non-woven structural fibers rolled to form the arrow shaft;
(b) said unidirectional structural fibers or the non-woven structural fibers formed into sheets being coated with a metal whereby the linear weight of the arrow shaft may be increased without significantly increasing the wall thickness or the diameter of the arrow shaft;
(c) a scrim composed of structural fibers oriented to extend around the arrow shaft to increase the hoop strength of the arrow shaft, said structural fibers of the scrim coated with a metal such that the linear weight of the arrow shaft may be selectively increased with minimal increase to the wall thickness or diameter of the arrow shaft; and
(d) an adhesive resin material for binding the unidirectional structural metal-coated fibers or the metal-coated non-woven structural fibers formed into sheets, as well as the structural fibers of the scrim.

9. The arrow shaft according to claim 8, wherein the weight of the arrow shaft along the length of the shaft may be altered through the amount of metal coating added to the structural fibers.

10. The arrow shaft according to claim 8, wherein the weight of the arrow shaft may be altered by the amount of metal coating added to the fibers of the structural scrim.

11. The arrow shaft according to claim 8, wherein weight is added to the arrow shaft by the metal coating of the structural fibers substantially uniformly along the length of the arrow shaft.

12. The arrow shaft according to claim 8, wherein weight is distributed differentially along the length of the arrow shaft by applying different patterns of structural fiber containing various amounts of metal coating.

13. The arrow shaft according to claim 8, wherein weight is added differentially along the length of the arrow shaft by utilizing a reinforcing scrim that has a gradient of metal applied to the structural fibers of the scrim in a gradient along the scrim.
